(19) United States
(12) Patent Application Publication
(10) Pub. No.: US 2023/0394385 A1
(43) Pub. Date: Dec. 7, 2023

(54) Sales Score Optimized Routing

(71) Applicant: TerriTool, LLC, Newport Beach, CA (US)

(72) Inventors: Spencer Kern Kelleher, Costa Mesa, CA (US); Anuj Sahni, Auckland (NZ); Deep Shah, Gujarat (IN)

(21) Appl. No.: 17/830,313

(22) Filed: Jun. 1, 2022

(51) Int. Cl. G06Q 10/04; G06Q 10/06

(52) U.S. Cl. CPC G06Q 10/047; G06Q 10/06393

(57) ABSTRACT

Systems and methods of the inventive subject matter are directed to route optimization that takes sales ratings into consideration. In some embodiments, users can request one of two different route types, a sales route or an optimized route. A sales route allows the user to hand pick waypoints to be visited, and the platform server then generates a route that visits all those waypoints. The route accounts for sales ratings that the user has assigned to each waypoint, as well as times and distances between each waypoint. An optimized route selects waypoints based on previously assigned sales ratings and then generates a route for the user, where the route similarly accounts for sales ratings as well as times and distances between each waypoint. Genetic algorithm techniques can be used to converge on high performing routes.

### FIELD OF THE INVENTION

The field of the invention is optimizing routing to visit one or more sets of waypoints.

### BACKGROUND

The background description includes information that may be useful in understanding the present invention. It is not an admission that any of the information provided in this application is prior art or relevant to the presently claimed invention, or that any publication specifically or implicitly referenced is prior art.

Many different industries involve developing and traveling along routes that include multiple different stops. A great example, of course, is package delivery. A delivery truck must visit dozens and sometimes hundreds of different waypoints in a single route. To maximize profit and minimize time spent driving, a route passing through many different waypoints needs to be optimized. But when the number of different waypoints that must be visited grows too large, traditional route optimization techniques begin to fail—it simply takes too long to optimize routes that have large numbers of waypoints, especially when routes need to be optimized and implemented quickly after a set of waypoints is defined.

In addition to optimizing a route based on time and distance between waypoints, it can be advantageous to also account for likelihood of closing sales. While efforts have been made in the past to create route optimization, these past efforts fail to consider that sales ratings can further be incorporated to create routes optimized for time, distance, as well as sales rating.

There is thus a need for improved route optimization techniques that make it possible to optimize routes that take into account large number of waypoints where waypoints can have sales ratings associated with them, and it has yet to be appreciated that genetic algorithm techniques can be implemented to take large waypoint sets, break them into clusters, and then optimize those subsets individually to create a highly-optimized route in a span of time orders of magnitude smaller than was previously possible.

### SUMMARY OF THE INVENTION

The present invention provides systems and methods directed to route optimization that accounts for time, distance, and sales ratings associated with a set of waypoints.

In one aspect of the inventive subject matter, a method of developing an optimized sales route is contemplated, the method comprising the steps of: receiving a set of waypoints; receiving a set of selected waypoints; receiving sales ratings for each waypoint in the set of selected waypoints; creating a time matrix having travel times between every waypoint in the set of selected waypoints; creating a distance matrix having straight line distances between every waypoint in the set of selected waypoints; computing a navigation matrix, where the navigation matrix is a function of both the time matrix and the distance matrix; creating a sales matrix based on the sales ratings; computing a final matrix, where the final matrix is a function of both the navigation matrix and the sales matrix; using the final matrix to create a set of waypoint clusters; creating an inter cluster route using the set of waypoint clusters; creating a set of intra cluster routes using the set of waypoint clusters and based on the inter cluster route; and developing a route comprising every waypoint in the set of selected waypoints, the route incorporating the set of intra cluster routes and the inter cluster route.

In some embodiments, the method according for a starting waypoint where the route begins at the starting waypoint. An ending waypoint can also be incorporated, where the route ends at the ending waypoint. Sales ratings can be received via user input. In some embodiments, the navigation matrix, the sales matrix, the final matrix are all square having the same dimensions.

In another aspect of the inventive subject matter, a method of developing an optimized sales route is contemplated, the method comprising the steps of: receiving a set of waypoints; receiving a set of selected waypoints; receiving sales ratings for each waypoint in the set of selected waypoints; creating a time matrix having travel times between every waypoint in the set of selected waypoints; creating a distance matrix having distances between every waypoint in the set of selected waypoints; computing a navigation matrix, where the navigation matrix is a function of both the time matrix and the distance matrix; creating a sales matrix based on the sales ratings; computing a final matrix, where the final matrix is a function of both the navigation matrix and the sales matrix; using the final matrix to create a set of waypoint clusters; developing a set of inter cluster routes using the waypoint clusters; developing a set of intra cluster routes using the waypoint clusters; developing a set of preliminary routes using the set of inter cluster routes and the set of intra cluster routes; evaluating a set of fitness factors using the set of preliminary routes; and identifying a route from the set of preliminary routes, the route having a higher fitness factor than all other routes.

As above, the sale rating can be received via user input. In some embodiments, the navigation matrix, the sales matrix, the final matrix are all square having the same dimensions. Distances between every waypoint in the set of selected waypoints can be calculated as straight-line distances. The set of inter cluster routes and the set of intra cluster routes can be developed randomly. In some embodiments, the method includes the step of adding the route to a set of possible routes, where the set of possible routes is subject to genetic algorithm techniques to identify a best route.

In another aspect of the inventive subject matter, a method of developing an optimized sales route for a set of waypoints is contemplated, the method comprising the steps of: computing distances between each waypoint in the set of waypoints, where each waypoint in the set of waypoints has a corresponding sales rating, computing travel times between each waypoint in the set of waypoints; creating a set of clusters of waypoints based on the distances, the travel times, and the sales ratings; developing a set of inter cluster routes using the set of clusters; developing a set of intra cluster routes using the set of clusters and based on the set of inter cluster routes; developing a set of proposed final routes, each proposed final route based on an inter cluster route and a set of intra cluster routes; evaluating fitness factors for each proposed final route in the set of proposed final routes; and identifying a final route from the set of proposed final routes based on the fitness factors.

In some embodiments, sales ratings are received via user input. Distances between every waypoint in the set of waypoints can be calculated as straight-line distances. The set of inter cluster routes can be developed randomly and the set of intra cluster routes can also be developed randomly. In some embodiments, the method also includes the step of adding the route to a set of possible routes, where the set of possible routes is subject to genetic algorithm techniques to identify a best route. Each waypoint in the set of waypoints can be algorithmically selected based on the corresponding sales ratings.

One should appreciate that the disclosed subject matter provides many advantageous technical effects including developing optimized routes that account for time, distance, and sales ratings.

Various objects, features, aspects, and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1 shows how information flows between client devices and service platforms of the inventive subject matter.

FIG. 2 is a flow chart showing route generation steps where a client applies sales ratings manually at the time of route generation.

FIG. 3 is a flow chart showing route generation steps where each waypoint already has a sales rating associated therewith.

FIG. 4 is a schematic showing how an embodiment of the inventive subject matter can be structured.

FIG. 5 shows how a user and a platform server can interact to generate a route.

FIG. 6 shows an alternative embodiment of how a user and a platform server can interact to generate a route.

FIG. 7 shows how genetic algorithm techniques can be used to optimize routes.

### DETAILED DESCRIPTION

The following discussion provides example embodiments of the inventive subject matter. Although each embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

As used in the description in this application and throughout the claims that follow, the meaning of “a,” “an,” and “the” includes plural reference unless the context clearly dictates otherwise. Also, as used in the description in this application, the meaning of “in” includes “in” and “on” unless the context clearly dictates otherwise.

Also, as used in this application, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

It should be noted that any language directed to a computer should be read to include any suitable combination of computing devices, including servers, interfaces, systems, databases, agents, peers, Engines, controllers, or other types of computing devices operating individually or collectively. One should appreciate the computing devices comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclosed apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network. The following description includes information that may be useful in understanding the present invention. It is not an admission that any of the information provided in this application is prior art or relevant to the presently claimed invention, or that any publication specifically or implicitly referenced is prior art.

Systems and methods of the inventive subject matter are directed to waypoint routing that considers soft factors in route generation. For example, some embodiments can be configured to generate routes that consider sales ratings for each waypoint. When a sales rating is assigned, either manually or by a platform server (e.g., algorithmically), that rating can influence route generation to, e.g., ensure waypoints that are associated with a better sales rating (e.g., a higher probability of completing a sale) are given priority over those with worse sales ratings. Route generation also accounts for times and distances between waypoints to ensure routes are optimized both for sales and for travel.

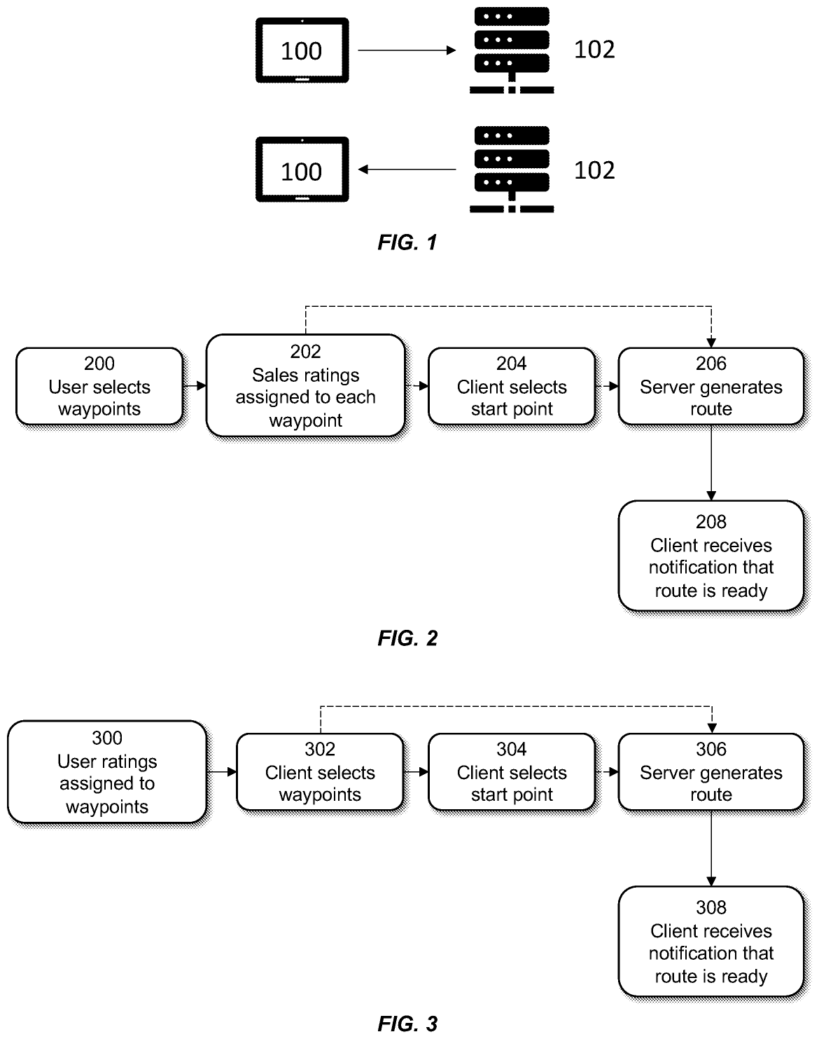

FIG. 1 shows generally how information flows between user devices and a platform server of the inventive subject matter. A user-operated computing device 100 (where a computing device can be, e.g., any network enabled device such as a tablet, a computer, a smartphone, etc.) can send information (e.g., a route request, waypoints, sales ratings, or any other data) to a platform server 102, and that platform server 102 can, in turn, send a response to the user's computing device 100 (e.g., an optimized route, a request for more information, or any other data). The computing device 100 and the platform server 102 can be informationally coupled by any type of network connection. Throughout this application, the terms “client” and “user” may be used. “Client” refers to a user's device such as a smart phone, computer, or tablet. A user is the human on the other side of the client. These terms are sometimes used interchangeably, and when an action is written as being undertaken by a user, it should be understood that the action is relayed by the client to the platform server. Similarly, when the client is described as taking an action that requires user input, it should be understood that the client's action is initiated by the user even if not every action is explicitly described.

FIG. 2 is a flowchart showing how an embodiment of the inventive subject matter can be configured to create optimized routes. In step 200, a user first selects a set of way points. For purposes of discussion, it should be understood that the “user” described in FIG. 2 can refer to, e.g., a user, a manager, or any other third party that may be responsible for or associated with a generated route in any way. A set of waypoints includes at least two waypoints and can theoretically have an unlimited number of waypoints. In practical terms, a number of waypoints in a set can be limited according to practical considerations such as vehicle range (e.g., vehicles can only visit so many locations before refueling/recharging), driver fatigue (e.g., drivers need breaks), work schedule (e.g., only so many waypoints can practically be visited in a person's shift), and so on. Waypoints can include names of places to be visited (e.g., a company name), addresses, GPS information, cities, states, postal codes, contact details such as mail IDs, phone numbers, mobile numbers, statuses, and so on.

Once a user has selected a set of waypoints, sales ratings can be assigned to each waypoint per step 202. Sales ratings can be assigned by, e.g., the user, by a managing user, or algorithmically. Sales ratings can be expressed numerically or alphabetically (e.g., as a value between 0-1 or 0-10, A-F, and so on). Next, optionally in step 204, the user can select a starting point. The starting point can be one of the selected waypoints or some other location. It is contemplated that, as with sales ratings, the starting point can be selected by a manager, a user, a manager, or the like. Step 204 can be skipped, in some embodiments, where, for example, the start location is not user-selected and is instead determined automatically (e.g., according to a GPS location of an individual that will travel the route).

In step 206, the server generates a route. Route generation considers all waypoints from step 200, all sales ratings associated with each waypoint, as well as a start point. In addition, the server can account for time and distance between each waypoint, which can account for traffic conditions, speed limits, and so on. The server thus uses that information to generate an optimized route that can be used, e.g., by a salesperson to visit sales sites or by an individual visiting job sites. Finally, in step 208, the server sends a notification to the client indicating that the route is ready, and the route is made accessible to the user (e.g., via browser, app, download, etc.).

FIG. 3 shows an alternative configuration of the embodiment shown in FIG. 2. Instead of assigning sales ratings to waypoints after a user has selected the waypoints, sales ratings are assigned to waypoints in step 300 before any waypoints are selected. This can be advantageous when, e.g., waypoints are stored in a database prior to selection. Waypoints stored in the database can have sales ratings associated with them while stored in the database such that when a set of waypoints are selected by a user, the user does not then have to assign a sales rating to each waypoint. Thus, in step 302, the user selects waypoints to be visited by a route. Optionally, in step 304, the user can select a start point, which can be one of the waypoints or some other location. In step 306 (which can come immediately after step 302 or step 304), the server generates a route, similar to step 206 described above. Finally, the client receives a notification that the route is ready, similar to step 308 described above.

It should be understood that although both FIGS. 2 and 3 describes in steps 208 and 308 that the client receives a notification that a route is ready, both those steps can also be interpreted as describing that the newly generated route is made available to the user via, e.g., web browser, app, etc. It is not required that a notification be delivered.

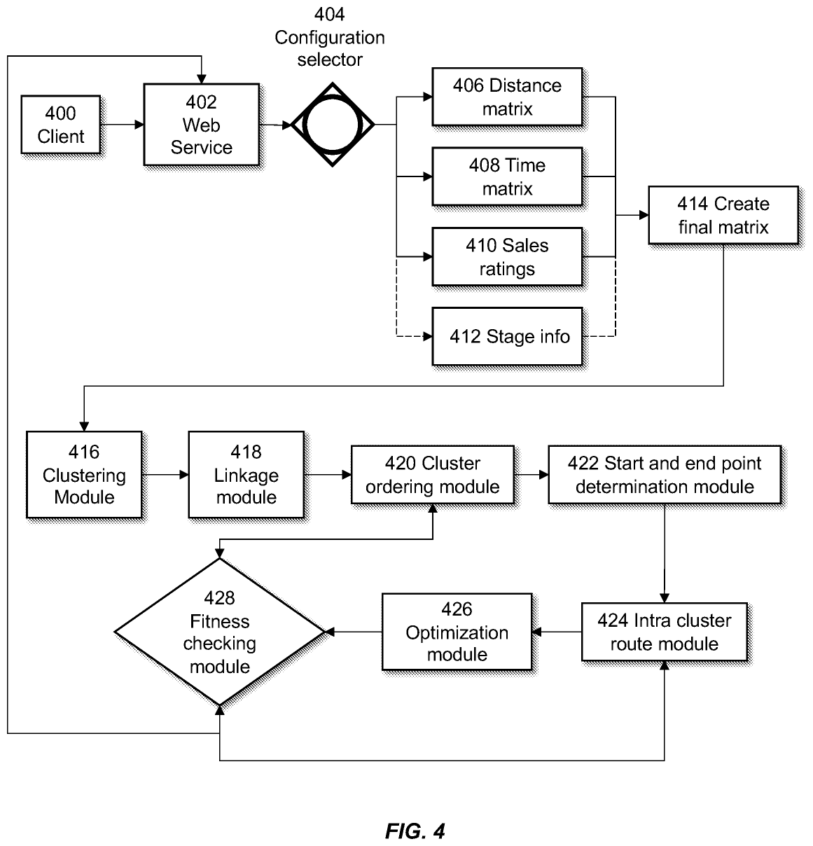

FIG. 4 is a flowchart providing additional details as to how embodiments of the inventive subject matter can generate optimized routes. Client 400 first accesses web service 402. Web service 402 is, e.g., software running on a platform server that clients can access via, e.g., web browser, app, etc. Next, client 400 sends a new route request to web service 402. Web service 402 also functions to manage software processes described below.

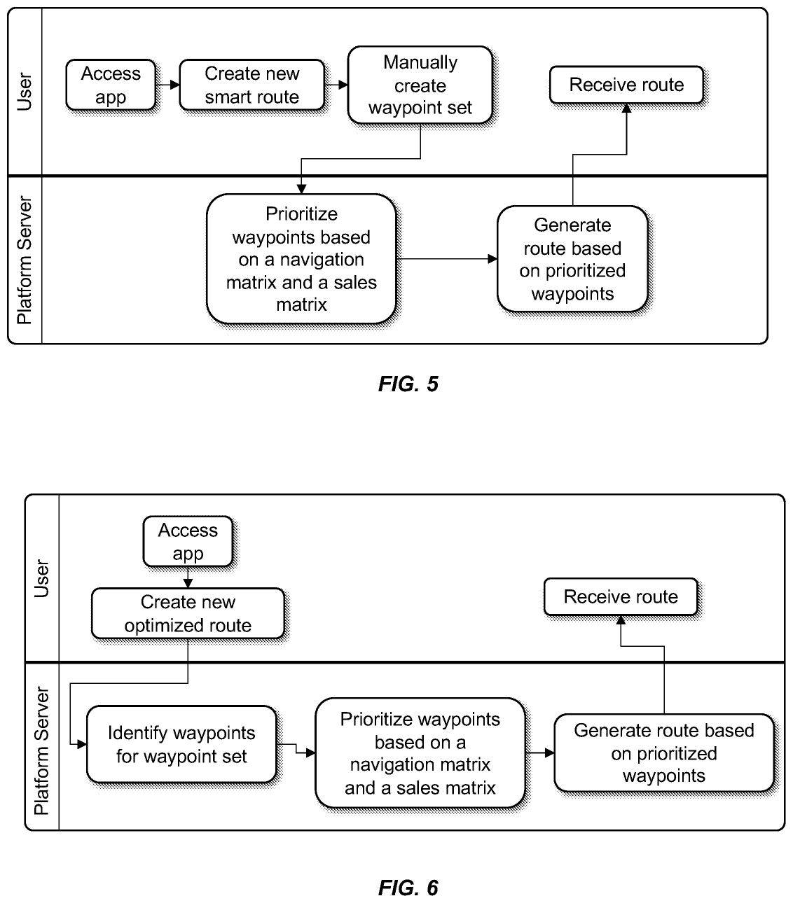

From there, the user must select a type of route, e.g., a smart route or a sales cycle route via the configuration selector 404. How these different routes are developed is discussed in more detail below relating to FIGS. 5 and 6.

Configuration selector 404 allows a user to select a type of route to develop, and two types contemplated in this application include a smart route and an optimized route. A smart route is a route that is created when a user manually selects waypoints, where each waypoint has a sales rating associated with it (e.g., where the user assigns those sales ratings). The platform server can then use those waypoints to generate an optimized route. Because each of the selected waypoints is associated with a sales rating, an optimized route is optimized at least in part to maximize sales potential while also accounting for time and distance between waypoints. Smart routes are thus skewed toward higher sales ratings (e.g., higher potential to complete a sale).

An optimized route is a route that is created when a user is given a set of waypoints that are selected by the platform server. Again, each waypoint has a sales rating associated with it, though in cases of optimized routes, those sales ratings can be assigned prior to waypoint selection as the platform server selects waypoints based on sales ratings. The platform server can then use those waypoints to generate an optimized route. Because each of the selected waypoints is associated with a sales rating—as with smart routes above—an optimized route is optimized at least in part to maximize sales potential while also accounting for time and distance between user-selected waypoints.

Once a user has selected either a smart route or an optimized route by interacting with configuration selector 404, the platform server develops a distance matrix 406, a time matrix 408, and retrieves sales ratings 410 associated with each waypoint. In some embodiments (e.g., optimized routes), stage information 412 is additionally considered, where stage information includes selection criteria for automatic waypoint selection that considers sales rating (e.g., only those waypoints above a certain sales rating are selected) as well as conflict information (e.g., whether visiting certain waypoints on the same route is even possible). In some embodiments, only those waypoints having sales ratings above an 8 on a scale of 1-10 are selected (it should be understood that this scale can be normalized and expressed in various ways without departing from the inventive subject matter).

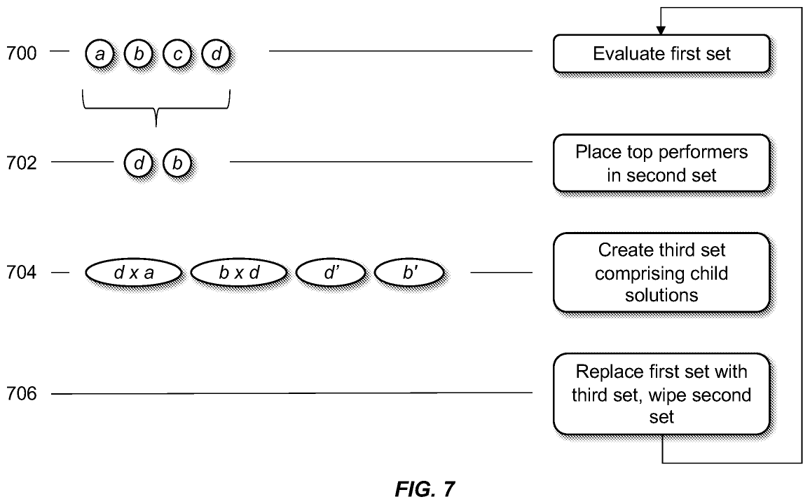

Using the time matrix, the distance matrix, and the sales ratings (e.g., expressed as a vector), a final matrix 414 can be created. The final matrix, which is described in more detail below, facilitates waypoint prioritization and clustering, and thus, the final matrix 414 is passed to a clustering module 416. Clustering module 416 breaks waypoints into clusters, where appropriate, and the clusters are then passed to linkage module 418. Linkage module 418 assesses clusters and can create links between clusters based on the final matrix, and the links can be used, e.g., to minimize the overall cost and for determining an order for an inter cluster route. Next, cluster ordering module 420 develops an inter cluster route (e.g., a route that goes from cluster to cluster, but not through each waypoint of each cluster). With an inter cluster route developed, intra cluster routes can be developed in the intra cluster route module 424. Finally, optimization module 426 is used to develop an optimized route that passes through every waypoint. Next, the fitness checking module 428 determines a fitness value for the route. This factor is stored, and the process is iterated through again for different routes to create a set of possible routes. This iterative process is described below in association with FIG. 7, which goes through genetic algorithm techniques that can be implemented to converge on a most optimized route.

The fitness checking module 428 is configured to facilitate genetic algorithm techniques by helping to determine which routes should be used for, e.g., crossover or mutation operations. Fitness checking can occur at different stages throughout route development. For example, an inter cluster route can have its fitness checked before an intra cluster route is developed, and an intra cluster route can also have its fitness checked. A final route can also have its fitness checked. By conducting fitness checks throughout the process, it is possible to optimize at various stages in the process of developing a final route.

FIG. 5 describes an example of how a smart route can be generated according to the inventive subject matter. First, a user accesses an app on a client device. In some embodiments, the app is software downloaded to the phone while in others the app is software as a service accessed through a web browser. Next, the user selects an option to create a new smart route. The user must then create a waypoint set by, e.g., inputting different locations (e.g., customer locations) and assigning sales ratings to each of those locations. The platform server then receives those waypoints with associated sales ratings and prioritizes those waypoints based on sales ratings, distances, and travel times.

FIG. 6 shows a flowchart of an alternative embodiment of the inventive subject matter. It is similar to the one shown in FIG. 5, but it is directed toward an embodiment where a set of waypoints is automatically generated instead of manually selected. Thus, a user accesses an app (e.g., via web browser or software application) and the user selects an option to create a new optimized route. From there, the platform server identifies waypoints for a set of waypoints. The waypoints added to the set can be selected based on sales ratings (e.g., only those sales ratings above a certain threshold are added). Next, the waypoints are prioritized before a route is generated and made available to the client.

The step of prioritizing waypoints and generating routes is described in more detail below. This process involves using a time matrix, a distance matrix, and a sales matrix to create a final matrix that enables waypoint prioritization.

Thus, in some embodiments, a time matrix is a square matrix of dimension n×n, where n is the number of waypoints to be used in a route (e.g., expressed as latitude/longitude pairs or location expressed in some other way). A completed time matrix expresses travel time between each waypoint to every other waypoint (e.g., as hours and minutes as shown in Table 1, or as seconds, minutes, hours, days, months, or any combination thereof, etc.). Table 1, below, shows an example time matrix where the numbers along the top and left side of the table represent waypoints.

TABLE 1
Time Matrix

| | 1 | 2 | 3 | 4 | 5 | 6 | 7 |
|---|---|---|---|---|---|---|---|
| 1 | 0 | 1:42 | 10:15 | 5:43 | 6:23 | 7:12 | 8:32 |
| 2 | 1:50 | 0 | 4:17 | 4:22 | 2:52 | 2:43 | 1:43 |
| 3 | 10:46 | 4:00 | 0 | 1:17 | 8:59 | 2:56 | 1:15 |
| 4 | 5:32 | 4:35 | 1:45 | 0 | 4:29 | 6:19 | 9:28 |
| 5 | 6:02 | 3:34 | 9:30 | 4:01 | 0 | 2:33 | 6:04 |
| 6 | 7:30 | 3:00 | 2:30 | 6:15 | 2:46 | 0 | 6:38 |
| 7 | 8:53 | 1:17 | 1:43 | 9:58 | 6:17 | 6:05 | 0 |

With a time matrix created, the platform server then calculates a distance matrix. The distance matrix can be calculated by, e.g., calculating cartesian equations expressing straight-line distances from each waypoint to every other waypoint. In some embodiments, the distance matrix comprises distances between waypoints that are calculated according to travel on roads. A distance matrix can also be expressed as a square, n×n matrix, which, like the time matrix in Table 1 above, can show distances from each waypoint to each other waypoint. For purposes of explanation, below, the distance matrix represents straight line distances between waypoints.

The following mathematics explanation is directed to embodiments of the inventive subject matter that use a distance matrix comprising straight-line distances between waypoints. In such embodiments, the time matrix and distance matrix, along with the sales scores for each waypoint, can be combined to create a final matrix. First, a navigation matrix, N, is calculated according to the following equation.

N=tT+dD

Navigation matrix N creates a representation of distance between waypoints that incorporates time to travel between those waypoints, where t and d are constants. In some embodiments, d+t=1. In general, each constant can be between 0-1, though in some circumstances, a constant can be greater than 1.

Another square matrix, sales matrix S, comprises sales ratings, where each member in S, expressed as Sᵢⱼ, can be obtained by adding the sales ratings of waypoints i and j, where i and j range from 1 to the total number of waypoints in a desire route (other mathematical operations can reach the same or similar results). S is a square matrix having the same dimensions as N. By introducing S, navigation matrix N can be scaled based on sales ratings for each waypoint. Sales matrix S is then normalized (i.e., the values are scaled to range from 0-1) to create Sₙₒᵣₘ.

With both navigation matrix N and normalized sales matrix Sₙₒᵣₘ, prepared, a final matrix, C, can be computed as a Hadamard product of N and Sₙₒᵣₘ, as expressed in the following equation:

C=N∘Sₙₒᵣₘ

Thus, final matrix C is a square matrix having the same dimensions as navigation matrix N and normalized sales matrix Sₙₒᵣₘ. Thus, each element of final matrix C results in a value that incorporates distance, time, and sales ratings for each set of two waypoints from a set of waypoints.

Final matrix C can therefore be used to cluster waypoints into groups. A cluster of waypoints is a subset of the total set of waypoints, and waypoint clusters are created based on values from the final matrix. Thus, each cluster of waypoints includes waypoints that are selected based on, e.g., how close they are to each other in time and distance as well as based on sales ratings. In some embodiments, waypoints that are associated with higher sales ratings are clustered together, and in instances where there are multiple clusters, the cluster with the waypoints having the highest sales ratings is generally put first in an inter cluster route (e.g., a route between clusters).

For each cluster of waypoints that is created, a representative waypoint can be identified, where the representative waypoint can be the first or last waypoint to be visited in an intra cluster route (e.g., a route within a cluster that visits each waypoint within that cluster). Inter cluster routes can then be generated using genetic algorithm techniques and the representative waypoints.

Thus, to develop a final route, intra cluster routes and inter cluster routes are generated. In some embodiments, an inter cluster route is generated (e.g., based on both waypoint final matrix values as well as representative waypoints from each cluster) and intra cluster routes are then generated (e.g., based on the inter cluster route as well as final matrix values). In some embodiments, once intra cluster routes are created (e.g., based on representative waypoints for each cluster as well as final matrix values), an inter cluster route is determined to obtain a final route. In any event, the final route is then made available to the client, e.g., via app, web browser, etc.

In some embodiments, inter cluster routes are developed through the use of genetic algorithm techniques and using the representative waypoints for each cluster. Intra cluster routes can similarly be determined using genetic algorithm techniques. Moreover, in some embodiments, genetic algorithm techniques can be applied using a set of routes is developed using randomly generated inter and intra cluster routes. The following discussion should be understood as applying to any set of routes, whether inter cluster, intra cluster, or routes developed from a combination of an inter cluster route and a set of intra cluster routes. FIG. 7 is a visualization of an example of an implementation of the genetic route development. In a first step 700, a set of solutions are evaluated (in this case, the set [a, b, c, d] where each member of the set is a possible intra or inter route solution). In some embodiments, these routes are generated at random (e.g., a route between all waypoints in a cluster, a route between all clusters, or a route incorporating a route between clusters and a set of intra cluster routes). Each route is evaluated to determine a fitness factor (e.g., a measure of how efficient the route is while accounting for time, distance, and sales rating), and those top performing routes are then put into a second set of possible solutions as shown in step 702. In this example, routes d and b were the top performers, so those are placed into the second set. Although 50% of the possible solutions from the first set are placed into the second set in this example, it is contemplated that the top 5%, 10%, 15%, 20%, 25%, 30%, 40%, 50%, 60%, 70%, 80%, or any value therebetween can be placed into the second set.

With routes d and b placed in the second set, those solutions can then both be used with crossover and mutation operations. As shown in step 304, solution d is crossed with solution a (using notation “d×d” to represent a crossover of d with a) and solution b is crossed with solution d. Although a is not a top performing solution from the first set, it can still be useful in a crossover operation. Both solutions d and b, on the other hand, are top performing solutions from the first set. Step 702 thus demonstrates that crossover operations can be conducted between members of the second set only, but also between one member of the second set and one member of the first set. At least one of the solutions subject to a crossover operation should be a member of the second set. The third set also includes mutated solutions d and b, denoted as d′ and b′. All these child solutions (d×a, b×d, b′ and d′) are all placed in a third set according to step 304.

With the third set completed, step 706 describes that the first set is replaced by the third set and the second set is wiped to make room for the top performers that are identified by repeating the first step, thus completing an iteration. Iterations of these steps are repeated until a final routing solution is converged upon. The number of iterative cycles that genetic algorithm development must undergo can be decided in real-time based on, e.g., the number of waypoints and how much subsequent fitness values improve over previous fitness values (e.g., in later iterations, fitness values will converge on an optimum and then fail to meaningfully improve beyond that). In practice, the number of iterations typically falls between 500 and 50,000. Once enough iterations are cycled through, the solution with the best fitness value (e.g., from the last set of route solutions, last 5 sets, 10 sets, 50 sets, or even last 100 sets of route solutions) is taken as the final solution.

In some embodiments, the first set of possible solutions are generated based on the number of waypoints by creating a possible solution for every single possible route that uses every single waypoint (e.g., when six or fewer waypoints exist in a set). In other embodiments, too many waypoints exist in a set of waypoints for it to be practical to generate a set of all possible solutions that include every single possible route through every waypoint-computation times to evaluate every possible route would be too long, making such a service useless. When too many waypoints exist, the first set of possible solutions is instead a subset of all possible solutions (e.g., an intra cluster route), and genetic algorithm techniques are relied on to arrive at an optimized solution after some number of iterations. By developing intra routing solutions for several different clusters as well as a route between clusters, optimized routes can be developed. Possible solutions subject to crossovers and mutations can be selected at random, while in other embodiments, possible solutions subject to crossovers and mutations can be selected as a function of fitness factor. In some embodiments, possible solutions subject to crossovers and mutations can be selected probabilistically. Possible solutions that undergo crossovers and mutations can also be selected in part at random and in part as a function of fitness factor.

As mentioned above, waypoint sets can be broken into clusters before the inventive subject matter is applied. This can help reduce computing time required for genetic algorithm techniques to converge on an optimal route by breaking up a set of waypoints into multiple clusters where each cluster can be optimized individually. In such embodiments, an inter cluster route and each intra cluster route can all have start and end points that can be considered during optimization. Start and end points for each individual cluster can depend on the location of a previous and subsequent cluster in an inter cluster route or on a previous start location for an inter cluster route or a subsequent end location for an inter cluster route (e.g., if there is no previous cluster or no subsequent cluster, respectively). If, for example, a set of way points is broken into three clusters, a first step can be to determine an order in which each cluster should be visited along a route. Order can be determined by, e.g., a start location and end location. Thus, if a first cluster is nearest a start location and a third cluster is nearest an end location, then the clusters can be visited in order (first, second, third). The number of clusters created from a set of waypoints depends on a variety of factors including relative waypoint locations and proximities, waypoint arrangements, number of waypoints, sales ratings, a final matrix as described above, etc.

Cluster makeup and the quantity of waypoints within a cluster can be determined on a route-by-route basis and can be determined based on geographical relativity. relationship of waypoints being considered, sales rating, and so on. For example, a 200-waypoint route may include 2 clusters, 8 clusters, 16 clusters, 50 clusters or any number of clusters therebetween (provided each cluster has at least two waypoints). There is not a theoretical upper limit to the number of waypoints or clusters that can be used with embodiments of the inventive subject matter.

In instances where a certain waypoint must be a start location and another waypoint must be an end location for a cluster, both the start and end locations can be considered when randomly generating possible routing solutions (e.g., both intra and inter cluster) by forcing those waypoints to be the start and endpoints for any possible solution. Moreover, crossover and mutation operations can be instructed not to affect those start and end points, thus ensuring a route begins and ends in desired locations.

For some number of waypoints (e.g., in a cluster or route), x, the total number of possible solutions is:

$$\frac{( x - 1 ) !}{2}$$

For many routing requests, too many waypoints exist for all possible solutions to be evaluated. When waypoints are broken n clusters, the number of random solutions to be generated can be the lesser of 200 and 8n, which can be expressed as min(200, 8n). A minimum of possible solutions to generate is determined empirically and can thus be adjusted. For example, it is also contemplated that the minimum number of solutions can be as low as min(100, 4n), as high as min(1000, 40n), or any minimum value therebetween. For example, using min(200, 8n), if there are 10 clusters, then the number of random solutions to be produced would be min(200, 800), which would result in 200 randomly generated solutions. The number of clusters (n) can depend on, e.g., the number of input waypoints, how close waypoints are to each other, and waypoint arrangements.

Whether a final routing solution (e.g., a solution that is sufficiently optimized) has been arrived at can be determined in several ways. Since for any given set of waypoints, it is unclear how many generations of solutions must be iterated through, instead, solution optimization can be measured in terms of generational improvement. For example, in early generations, the top performing solutions can improve over previous generation top performing solutions a higher percent than in later generation (e.g., where fitness factors are used to determine performance increases between generations). In earlier generations, improvements may range from, e.g., 5-15%, but as the number of generations increases, improvements begin to slow down as a final solution is converged upon. Thus, it has been discovered that cutting off solution development when intergenerational solution improvement reaches 2% leads to a high-performing final solution without adding additional time to solution development unnecessarily. It is contemplated that solution development can alternatively be cutoff anywhere between 1-4%, depending on such factors as computational power and speed, as well as a user's needs (e.g., how well-optimized does the final solution need to be, how quickly is a final solution needed, etc.).

Once an optimized solution is identified it can be stored to the platform server or, in some embodiments, sent to a different server where it can be made accessible to a user. In some embodiments, the optimized solution is automatically transmitted to the user upon identification, and in other embodiments, the optimized solution is sent upon user request. Regardless, once an optimized solution is identified, it can be accessed by one or more users.

Thus, specific systems and methods of route optimization that account for time, distance, and sales ratings have been disclosed. It should be apparent, however, to those skilled in the art that many more modifications besides those already described are possible without departing from the inventive concepts in this application. The inventive subject matter, therefore, is not to be restricted except in the spirit of the disclosure. Moreover, in interpreting the disclosure all terms should be interpreted in the broadest possible manner consistent with the context. In particular the terms “comprises” and “comprising” should be interpreted as referring to the elements, components, or steps in a non-exclusive manner, indicating that the referenced elements, components, or steps can be present, or utilized, or combined with other elements, components, or steps that are not expressly referenced.

What is claimed is:

1. A method of developing an optimized sales route comprising:
receiving a set of waypoints;
receiving a set of selected waypoints;
receiving sales ratings for each waypoint in the set of selected waypoints;
creating a time matrix having travel times between every waypoint in the set of selected waypoints;
creating a distance matrix having straight line distances between every waypoint in the set of selected waypoints;
computing a navigation matrix, wherein the navigation matrix is a function of both the time matrix and the distance matrix;
creating a sales matrix based on the sales ratings;
computing a final matrix, wherein the final matrix is a function of both the navigation matrix and the sales matrix;
using the final matrix to create a set of waypoint clusters;
creating an inter cluster route using the set of waypoint clusters;
creating a set of intra cluster routes using the set of waypoint clusters and based on the inter cluster route; and
developing a route comprising every waypoint in the set of selected waypoints, the route incorporating the set of intra cluster routes and the inter cluster route.

2. The method of claim 1, further comprising a starting waypoint, wherein the route begins at the starting waypoint.

3. The method of claim 1, further comprising an ending waypoint, wherein the route ends at the ending waypoint.

4. The method of claim 1, wherein sales ratings are received via user input.

5. The method of claim 1, wherein the navigation matrix, the sales matrix, the final matrix are all square having the same dimensions.

6. A method of developing an optimized sales route comprising:
receiving a set of waypoints;
receiving a set of selected waypoints;
receiving sales ratings for each waypoint in the set of selected waypoints;
creating a time matrix having travel times between every waypoint in the set of selected waypoints;
creating a distance matrix having distances between every waypoint in the set of selected waypoints;
computing a navigation matrix, wherein the navigation matrix is a function of both the time matrix and the distance matrix;
creating a sales matrix based on the sales ratings;
computing a final matrix, wherein the final matrix is a function of both the navigation matrix and the sales matrix;
using the final matrix to create a set of waypoint clusters;
developing a set of inter cluster routes using the waypoint clusters;
developing a set of intra cluster routes using the waypoint clusters;
developing a set of preliminary routes using the set of inter cluster routes and the set of intra cluster routes;
evaluating a set of fitness factors using the set of preliminary routes; and
identifying a route from the set of preliminary routes, the route having a higher fitness factor than all other routes.

7. The method of claim 6, wherein sales ratings are received via user input.

8. The method of claim 6, wherein the navigation matrix, the sales matrix, the final matrix are all square having the same dimensions.

9. The method of claim 6, wherein the distances between every waypoint in the set of selected waypoints are calculated as straight-line distances.

10. The method of claim 6, wherein the set of inter cluster routes are developed randomly and the set of intra cluster routes are developed randomly.

11. The method of claim 6, further comprising the step of adding the route to a set of possible routes, wherein the set of possible routes is subject to genetic algorithm techniques to identify a best route.

12. A method of developing an optimized sales route for a set of waypoints, the method comprising:
computing distances between each waypoint in the set of waypoints;
computing travel times between each waypoint in the set of waypoints;
wherein each waypoint in the set of waypoints has a corresponding sales rating;
creating a set of clusters of waypoints based on the distances, the travel times, and the sales ratings;
developing a set of inter cluster routes using the set of clusters;
developing a set of intra cluster routes using the set of clusters and based on the set of inter cluster routes;
developing a set of proposed final routes, each proposed final route based on an inter cluster route and a set of intra cluster routes;
evaluating fitness factors for each proposed final route in the set of proposed final routes; and
identifying a final route from the set of proposed final routes based on the fitness factors.

13. The method of claim 12, wherein sales ratings are received via user input.

14. The method of claim 12, wherein the distances between every waypoint in the set of waypoints are calculated as straight-line distances.

15. The method of claim 12, wherein the set of inter cluster routes are developed randomly and the set of intra cluster routes are developed randomly.

16. The method of claim 12, further comprising the step of adding the route to a set of possible routes, wherein the set of possible routes is subject to genetic algorithm techniques to identify a best route.

17. The method of claim 12, wherein each waypoint in the set of waypoints is algorithmically selected based on the corresponding sales ratings.
